(19) United States
(12) Patent Application Publication
(10) Pub. No.: US 2018/0088402 A1
(43) Pub. Date: Mar. 29, 2018

(54) Liquid Crystal Display Panel and Liquid Crystal Display

(71) Applicant: SHENZHEN CHINA STAR OPTOELECTRONICS TECHNOLOGIES CO., LTD., Shenzhen, Guangdong (CN)

(72) Inventor: Liwang SONG, Shenzhen (CN)

(21) Appl. No.: 15/128,926

(22) PCT Filed: Jun. 16, 2016
(86) PCT No.: PCT/CN2016/086007

§ 371 Date: Sep. 23, 2016

(30) Foreign Application Priority Data
Apr. 13, 2016 (CN) 201610227282.8

(51) Int. Cl. G02F 1/1335; G02F 1/1343

(52) U.S. Cl. CPC G02F 1/133514; G02F 1/1343

(57) ABSTRACT

The present disclosure proposes a liquid crystal display (LCD) panel. The LCD panel includes a first glass substrate, a second glass substrate, a semiconductor active layer, a source, a drain, a second dielectric layer, and a color filter layer. A third conductive layer and constructive pads are positioned on a connection region between two resistor layers among the plurality of red color resistor layers, the green color resistor layers, and the blue color resistor layers. The third conductive layer covers top surfaces of the constructive pads and the connection region. The present disclosure avoids the bubble problem and reduces the manufacturing process for manufacturing the LCD panels.

### BACKGROUND OF THE INVENTION

### 1. Field of the Invention

The invention relates to a liquid crystal display (LCD), and more particularly, to a liquid crystal display panel and a liquid crystal display (LCD).

### 2. Description of the Prior Art

Liquid Crystal Display (LCD) has been widely used because of its thin, power saving, and non-radiative characteristics. For example, LCD televisions (TVs), mobile phones, PDAs, digital cameras, computer screens, or laptops all utilize LCD as their display panel. Most of the LCDs are backlight-type LCDs. The backlight-type LCD comprises a LCD panel and a backlight module. Specifically, liquid crystals are injected into the space between the thin film transistor array substrate (TFT array substrate) and color filter (CF) substrate. Furthermore, driving voltages are applied on the two substrates to control the rotation of the liquid crystals to refract the lights generated by the backlight module so that the images can be displayed on the LCDs.

Conventionally, the CF substrate comprises red, blue, green color resistor layer to filter the lights. However, lights may pass through the boundary of two color filter layers. Therefore, a black material should be positioned on the boundary to block the lights. For example, one solution is to put a black matrix on the light-leakage areas. Another solution is to position ITO layers on the light-leakage areas of the two substrates and set voltage levels of the ITO layers equal. In order to set the voltage levels of the ITO layers equal, ITO layers are connected to the common electrode (the conductive layer of the TFT array substrate is also equal to the voltage level of the common electrode). However, the color filter layer needs to have a via to allow the ITO layer to contact the common electrode through the color filter layer. This means another manufacturing process should be added to form the via of the color filter layer and the LCD panel may have a bubble if this manufacturing process is not correctly performed.

### SUMMARY OF THE INVENTION

It is therefore one of the primary objectives of the claimed invention to provide an LCD panel and related LCD, to solve the bubble problem and manufacturing process problem caused by manufacturing the via in the color filter layer to allow the conductive line to connect the color filter layer and the common electrode.

According to an exemplary embodiment of the claimed invention, a liquid crystal display (LCD) panel is disclosed. The LCD panel comprises: a first glass substrate, where a first conductive layer is positioned on an inner of the first glass substrate; and a second glass substrate, corresponding to the first glass substrate, the second glass substrate comprising: a gate and a common electrode formed on the second glass substrate; a first dielectric protection layer, positioned on the gate and the common electrode; a semiconductor active layer, a source, and a drain, formed on the first dielectric protection layer; a second dielectric layer, formed on the semiconductor active layer, the source, and the drain; and a color filter layer, comprising a plurality of red color resistor layers, a plurality of green color resistor layers, and a plurality of blue color resistor layers, formed on the second dielectric layer; wherein a third conductive layer and a plurality of constructive pads are positioned on a connection region between two resistor layers among the plurality of red color resistor layers, the green color resistor layers, and the blue color resistor layers; the constructive pads are formed by overlapping at least two resistor layers among the plurality of red color resistor layers, the green color resistor layers, and the blue color resistor layers; the third conductive layer covers top surfaces of the constructive pads and the connection region, a conductive structure is positioned on surfaces of the constructive pads, wherein when the first glass substrate and the second glass substrate are connected, the first conductive layer and the third conductive layer contact and electrically connect to each other, wherein the first conductive layer and the third conductive layer are manufactured by Indium tin oxide (ITO) materials.

Preferably, the color filter layer has at least one via corresponding to the drain, the via passes through the color filter layers and the second dielectric protection layer to the drain, and a second conductive layer is positioned on the via, a bottom of the second conductive layer contacts the drain and two ends of an opening of the second conductive layer contacts the color filter layer.

Preferably, the constructive pad is a single-color constructive pad.

Preferably, the constructive pad is formed by two resistor layers of different colors.

According to the present invention, a liquid crystal display (LCD) panel comprises: a first glass substrate, where a first conductive layer is positioned on an inner of the first glass substrate; and a second glass substrate, corresponding to the first glass substrate, the second glass substrate comprising: a gate and a common electrode formed on the second glass substrate; a first dielectric protection layer, positioned on the gate and the common electrode; a semiconductor active layer, a source, and a drain, formed on the first dielectric protection layer; a second dielectric layer, formed on the semiconductor active layer, the source, and the drain; and a color filter layer, comprising a plurality of red color resistor layers, a plurality of green color resistor layers, and a plurality of blue color resistor layers, formed on the second dielectric layer. A third conductive layer and a plurality of constructive pads are positioned on a connection region between two resistor layers among the plurality of red color resistor layers, the green color resistor layers, and the blue color resistor layers; the third conductive layer covers top surfaces of the constructive pads and the connection region, a conductive structure is positioned on surfaces of the constructive pads. When the first glass substrate and the second glass substrate are connected, the first conductive layer and the third conductive layer contact and electrically connect to each other through the conductive structure.

Preferably, the color filter layer has at least one via corresponding to the drain, the via passes through the color filter layers and the second dielectric protection layer to the drain, and a second conductive layer is positioned on the via, a bottom of the second conductive layer contacts the drain and two ends of an opening of the second conductive layer contacts the color filter layer.

Preferably, the constructive pad is a base substrate.

Preferably, the constructive pads are formed by overlapping at least two resistor layers selected from the plurality of red color resistor layers, the green color resistor layers, and the blue color resistor layers.

Preferably, the constructive pad is formed by two color resistor layers of an identical color.

Preferably, the constructive pad is formed by two color resistor layers of different colors.

Preferably, the first conductive layer, the second conductive layer, and the third conductive layer are manufactured by Indium tin oxide (ITO) materials.

According to the present invention, a liquid crystal display (LCD) comprises an LCD panel. The LCD panel comprises: a first glass substrate, where a first conductive layer is positioned on an inner of the first glass substrate; and a second glass substrate, corresponding to the first glass substrate, the second glass substrate comprising: a gate and a common electrode formed on the second glass substrate; a first dielectric protection layer, positioned on the gate and the common electrode; a semiconductor active layer, a source, and a drain, formed on the first dielectric protection layer; a second dielectric layer, formed on the semiconductor active layer, the source, and the drain; and a color filter layer, comprising a plurality of red color resistor layers, a plurality of green color resistor layers, and a plurality of blue color resistor layers, formed on the second dielectric layer. A third conductive layer and a plurality of constructive pads are positioned on a connection region between two resistor layers among the plurality of red color resistor layers, the green color resistor layers, and the blue color resistor layers; the third conductive layer covers top surfaces of the constructive pads and the connection region, a conductive structure is positioned on surfaces of the constructive pads. When the first glass substrate and the second glass substrate are connected, the first conductive layer and the third conductive layer contact and electrically connect to each other through the conductive structure.

Preferably, the constructive pads are formed by overlapping at least two resistor layers selected from the plurality of red color resistor layers, the green color resistor layers, and the blue color resistor layers.

Preferably, the constructive pad is formed by two color resistor layers of different colors.

Preferably, the constructive pad is formed by two color resistor layers of an identical color.

Preferably, the constructive pad is a base substrate.

Preferably, the first conductive layer is manufactured by Indium tin oxide (ITO) material.

Preferably, the second conductive layer is manufactured by Indium oxide (ITO) material.

Preferably, the third conductive layer is manufactured by Indium tin oxide (ITO) material.

Preferably, the conductive structure is manufactured by Indium tin oxide (ITO) material.

In contrast to the related art, the conductive structure according to an exemplary embodiment is positioned on the constructive pad. The first conductive layer of the first glass substrate, through the conductive structure, contacts and electrically connects to the third conductive layer of connection region between two resistor layers among the red resistor layers, green resistor layers, and blue resistor layers. In this way, the voltage levels of the first conductive layer and the third conductive layer are the same such that the liquid crystals of the connection region may not rotate. This avoids the bubble problem and reduces the manufacturing process for manufacturing the LCD panels.

### BRIEF DESCRIPTION OF THE DRAWINGS

FIG. 1 is a diagram showing a cross-section of an LCD panel according to an exemplary embodiment.

FIG. 2 is a diagram showing a cross-section of an LCD panel according to an exemplary embodiment.

### DETAILED DESCRIPTION OF THE PREFERRED EMBODIMENT

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

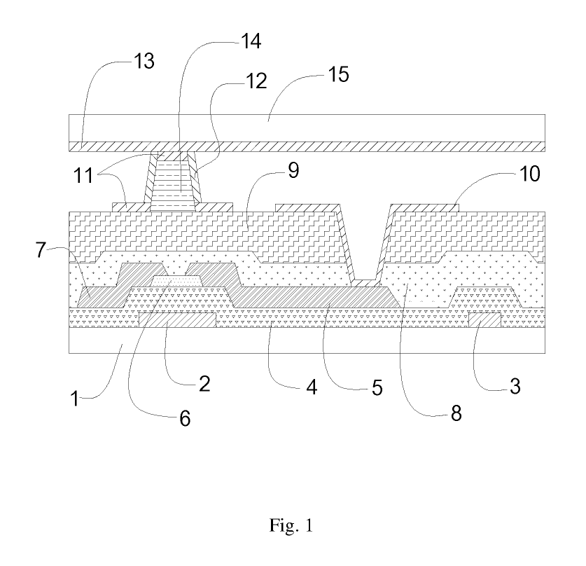

Please refer to FIG. 1, which is a diagram showing a cross-section of an LCD panel according to an exemplary embodiment. The LCD panel comprises a first glass substrate 15, where a first conductive layer 13 is positioned in the inner of the first glass substrate 15. The LCD panel further comprises a second glass substrate 1 corresponding to the first glass substrate 15. The second glass substrate 1 comprises: a gate 2 and a common electrode 3 formed on the second glass substrate 1; a first dielectric protection layer 4 formed on the gate 2 and the common electrode 3; a semiconductor active layer 6, a source 7 and a drain 5, formed on the first dielectric layer 4; a second dielectric protection layer 8, formed on the semiconductor active layer 6, the source 7, and the drain 5; a color filter layer 9 formed on the second dielectric protection layer 8. The color filter layer 9 comprises a plurality of red color resistor layers, a plurality of green color resistor layers, and a plurality of blue color resistor layers.

A third conductive layer 11 and a plurality of constructive pads 14 are positioned on the connection region between two color filter layers among the red color resistor layers, the green color resistor layers, blue color resistor layers. The third conductive layer 11 covers the top surface of all constructive pads 14 and the aforementioned connection region. A conductive structure 12 is positioned on the surface of the constructive pad 14. When the first glass substrate 15 and the second glass substrate 1 are connected, the first conductive layer 13 contacts and electrically connects the third conductive layer 11 through the conductive structure 12.

In this embodiment, the connection region is the aforementioned light-leakage region. The third conductive layer 11 contacts and electrically connects the first conductive layer 13 through the conductive structure 12. In this way, the voltage levels of the third conductive layer 11 and the first conductive layer 13 are the same. Therefore, when the first glass substrate 15 and the second glass substrate 1 are connected, the liquid crystals between the third conductive layer 11 and the first conductive layer 13 are not rotated to leak the lights. In addition, there is no need to use a conducting line to connect the third conductive layer 11 to the common electrode 3. That is, there is no need to provide a via in the color filter layer 9 for the conducting line. Therefore, the conventional bubble problem is prevented and the manufacturing process is simplified.

In this embodiment, the color resistor 9 has a via corresponding to the drain 5. The via pass through the color filter layer 9 and the second dielectric layer 8 to the drain 5. The second conductive layer 10 is positioned on the via structure. The bottom end of the second conductive layer 10 contacts the drain 5 and the two ends of the opening of the second conductive layer 10 contacts the color filter layer 9.

In this embodiment, the constructive pad 14 is a base substrate.

In this embodiment, the constructive pad 14 is formed by overlapping color filter layers 9. This configuration simplifies the manufacturing process of the LCD panel. This makes it possible to directly form a constructive pad after the color filter layer 9 is formed.

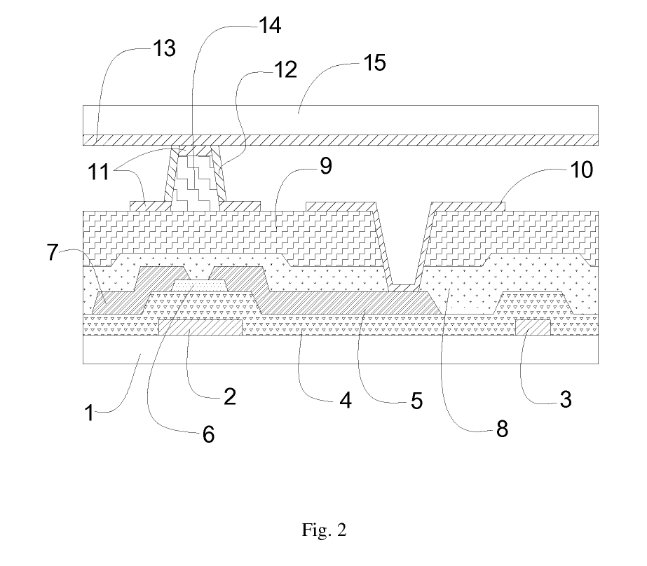

Please refer to FIG. 2, which is a diagram showing a cross-section of an LCD panel according to an exemplary embodiment. The LCD panel comprises a first glass substrate 15, a first conductive layer 13, a second glass substrate 1, a gate 2, and a common electrode 3, a first dielectric protection layer 4, a semiconductor active layer 6, a source 7, a drain 5, a second dielectric protection layer 8, and a resistor layer 9. The difference between the LCD panels shown in FIG. 1 and FIG. 2 is that the constructive pad 14 is a pad formed by overlapping the color filter layer 9, not a liner.

In this embodiment, the constructive pad may be a single-color constructive pad. That is, the constructive pad can be a red color resistor pad (formed by red color resistor layers), a green color resistor pad or a blue color resistor pad.

In this embodiment, the constructive pad may be formed by overlapping two resistor layers of different colors. That is, the constructive pad can be red-blue, red-green, blue-green, and red-blue-green constructive pad.

Furthermore, the first conductive layer 13, the second conductive layer 10, the third conductive layer 11, and the conductive construction 12 are implemented with Indium tin oxide (ITO) material. ITO materials have conductive and transparent characteristics and thus a good choice for LCD panel.

According to the present disclosure, the conductive structure 12 according to an exemplary embodiment is positioned on the constructive pad 14. The first conductive layer 13 of the first glass substrate 15, through the conductive structure 12, contacts and electrically connects to the third conductive layer 11 of connection region between two resistor layers among the red resistor layers, green resistor layers, and blue resistor layers. In this way, the voltage levels of the first conductive layer 13 and the third conductive layer 11 are the same such that the liquid crystals of the connection region may not rotate. This avoids the bubble problem and reduces the manufacturing process for manufacturing the LCD panels.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A liquid crystal display (LCD) panel, comprising:
a first glass substrate, where a first conductive layer is positioned on an inner of the first glass substrate; and
a second glass substrate, corresponding to the first glass substrate, the second glass substrate comprising:
a gate and a common electrode formed on the second glass substrate;
a first dielectric protection layer, positioned on the gate and the common electrode;
a semiconductor active layer, a source, and a drain, formed on the first dielectric protection layer;
a second dielectric layer, formed on the semiconductor active layer, the source, and the drain; and
a color filter layer, comprising a plurality of red color resistor layers, a plurality of green color resistor layers, and a plurality of blue color resistor layers, formed on the second dielectric layer;
wherein a third conductive layer and a plurality of constructive pads are positioned on a connection region between two resistor layers among the plurality of red color resistor layers, the green color resistor layers, and the blue color resistor layers; the constructive pads are formed by overlapping at least two color resistor layers selected from the plurality of red color resistor layers, the green color resistor layers, and the blue color resistor layers; the third conductive layer covers top surfaces of the constructive pads and the connection region, a conductive structure is positioned on surfaces of the constructive pads,
wherein when the first glass substrate and the second glass substrate are connected, the first conductive layer and the third conductive layer contact and electrically connect to each other through the conductive structure,
wherein the first conductive layer, the second conductive layer, the third conductive layer and the conductive structure are manufactured by Indium tin oxide (ITO) materials.

2. The LCD panel of claim 1, wherein the color filter layer has at least one via corresponding to the drain, the via passes through the color filter layers and the second dielectric protection layer to the drain, and a second conductive layer is positioned on the via, a bottom of the second conductive layer contacts the drain and two ends of an opening of the second conductive layer contacts the color filter layer.

3. The LCD panel of claim 1, wherein the constructive pad is a single-color constructive pad.

4. The LCD panel of claim 1, wherein the constructive pad is formed by two resistor layers of different colors.

5. A liquid crystal display (LCD) panel, comprising:
a first glass substrate, where a first conductive layer is positioned on an inner of the first glass substrate; and
a second glass substrate, corresponding to the first glass substrate, the second glass substrate comprising:
a gate and a common electrode formed on the second glass substrate;
a first dielectric protection layer, positioned on the gate and the common electrode;
a semiconductor active layer, a source, and a drain, formed on the first dielectric protection layer;
a second dielectric layer, formed on the semiconductor active layer, the source, and the drain; and
a color filter layer, comprising a plurality of red color resistor layers, a plurality of green color resistor layers, and a plurality of blue color resistor layers, formed on the second dielectric layer;
wherein a third conductive layer and a plurality of constructive pads are positioned on a connection region between two resistor layers among the plurality of red color resistor layers, the green color resistor layers, and the blue color resistor layers; the third conductive layer covers top surfaces of the constructive pads and the connection region, a conductive structure is positioned on surfaces of the constructive pads,
wherein when the first glass substrate and the second glass substrate are connected, the first conductive layer and the third conductive layer contact and electrically connect to each other through the conductive structure.

6. The LCD panel of claim 5, wherein the color filter layer has at least one via corresponding to the drain, the via passes through the color filter layers and the second dielectric protection layer to the drain, and a second conductive layer is positioned on the via, a bottom of the second conductive layer contacts the drain and two ends of an opening of the second conductive layer contacts the color filter layer.

7. The LCD panel of claim 5, wherein the constructive pad is a base substrate.

8. The LCD panel of claim 5, wherein the constructive pads are formed by overlapping at least two resistor layers selected from the plurality of red color resistor layers, the green color resistor layers, and the blue color resistor layers.

9. The LCD panel of claim 8, wherein the constructive pad is formed by two color resistor layers of an identical color.

10. The LCD panel of claim 8, wherein the constructive pad is formed by two color resistor layers of different colors.

11. The LCD panel of claim 5, wherein the first conductive layer, the second conductive layer, and the third conductive layer are manufactured by Indium tin oxide (ITO) materials.

12. A liquid crystal display (LCD) comprising an LCD panel, the LCD panel comprising:
a first glass substrate, where a first conductive layer is positioned on an inner of the first glass substrate; and
a second glass substrate, corresponding to the first glass substrate, the second glass substrate comprising:
a gate and a common electrode formed on the second glass substrate;
a first dielectric protection layer, positioned on the gate and the common electrode;
a semiconductor active layer, a source, and a drain, formed on the first dielectric protection layer;
a second dielectric layer, formed on the semiconductor active layer, the source, and the drain; and
a color filter layer, comprising a plurality of red color resistor layers, a plurality of green color resistor layers, and a plurality of blue color resistor layers, formed on the second dielectric layer;
wherein a third conductive layer and a plurality of constructive pads are positioned on a connection region between two resistor layers among the plurality of red color resistor layers, the green color resistor layers, and the blue color resistor layers; the third conductive layer covers top surfaces of the constructive pads and the connection region, a conductive structure is positioned on surfaces of the constructive pads,
wherein when the first glass substrate and the second glass substrate are connected, the first conductive layer and the third conductive layer contact and electrically connect to each other through the conductive structure.

13. The LCD of claim 12, wherein the constructive pads are formed by overlapping at least two resistor layers selected from the plurality of red color resistor layers, the green color resistor layers, and the blue color resistor layers.

14. The LCD of claim 13, wherein the constructive pad is formed by two color resistor layers of different colors.

15. The LCD of claim 13, wherein the constructive pad is formed by two color resistor layers of an identical color.

16. The LCD of claim 12, wherein the constructive pad is a base substrate.

17. The LCD of claim 12, wherein the first conductive layer is manufactured by Indium tin oxide (ITO) material.

18. The LCD of claim 12, wherein the second conductive layer is manufactured by Indium tin oxide (ITO) material.

19. The LCD of claim 12, wherein the third conductive layer is manufactured by Indium tin oxide (ITO) material.

20. The LCD of claim 12, wherein the conductive structure is manufactured by Indium tin oxide (ITO) material.
